(19) United States
(12) Patent Application Publication
(10) Pub. No.: US 2010/0231810 A1
(43) Pub. Date: Sep. 16, 2010

(54) DISPLAY DEVICE, LIQUID CRYSTAL DISPLAY DEVICE, TELEVISION SET

(76) Inventor: Motomitsu Itoh, Osaka (JP)

Correspondence Address: HARNESS, DICKEY & PIERCE, P.L.C., P.O. BOX 8910, RESTON, VA, 20195, US

(21) Appl. No.: 12/733,723

(22) PCT Filed: Sep. 17, 2008
(86) PCT No.: PCT/JP2008/066776

§ 371 Date: Mar. 17, 2010

(30) Foreign Application Priority Data
Nov. 7, 2007 (JP) 2007-290130

(51) Int. Cl. H04N 5/50; G09G 5/00

(52) U.S. Cl. 348/731; 345/213; 348/E05.097

(57) ABSTRACT

A display device has a display section provided with first and second areas each having formed therein data signal lines, scanning signal lines, and pixels. The scanning signal lines are individually scanned for each area so that a part (upper field) of a frame is displayed in the first area and a remaining part (lower field) of the frame is displayed in the second area. The scanning directions in the areas are identical. In display processing of a frame 0, the scanning signal line (G541) at the head of the second area is scanned one horizontal scanning period (1H) later than a scanning of the scanning signal line (G540) at the tail of the first area. In display processing of a frame 1 subsequent to the frame 0, the scanning signal line (G541) at the head of the second area is scanned at the same timing as a scanning of the scanning signal line (G540) at the tail of the first area. According to the arrangement, belt-like unevenness at the center is hard to be recognized in the case of the display device in which the display section is divided into the first and second areas and the respective areas are individually driven.

### TECHNICAL FIELD

The present invention relates to (i) a display apparatus which has a display section divided into a plurality of areas and which scans scanning signal lines individually for each of the plurality of areas, and (ii) a drive circuit of the display apparatus.

### BACKGROUND ART

In order that a writing time for each pixel may be reduced in response to higher definition of display apparatuses (e.g., liquid crystal display apparatuses) and rounding of a waveform due to upsizing of display apparatuses may be suppressed, there has been proposed an arrangement in which a display section is divided into a plurality of areas so that the plurality of areas may be driven individually. For ,example, Patent Literature 1 (see FIG. 16) discloses a display apparatus which has a display section divided into a first area and a second area, and has a source driver 102 and a gate driver 103 which drive the first area, and a source driver 102′ and a gate driver 103′ which drive the second area. The first area has a plurality of source lines (HS1 through HSm) and a plurality of gate lines (G1 through G(n/2)), and the second area has a plurality of source lines (HS1′ through HSm′) and a plurality of gate lines (G(n/2+1) through Gn). Hereinafter, the gate lines G(n/2), G(n/2+1), and Gn are referred to as G540, G541, and G1080, respectively.

It is conceivable to drive scanning signal lines of a display section illustrated in FIG. 16 so that, as shown in FIG. 14 for example, a scanning of G1 (scanning signal line at a head of the first area) and a scanning of G541 (scanning signal line at a head of the second area) to be carried out for displaying a frame N may be carried out at a same timing, and a scanning of G540 (scanning signal line at a tail of the first area) and a scanning of G1080 (scanning signal line at a tail of the second area) to be carried out for displaying the frame N are carried out at a same timing. However, a problem caused by this is that the first area and the second area look out of synchronization. This is because G540 and G541, which are sequentially scanned in the case of ordinary display processing (i.e., in a case where one display screen is not divided into two areas but is sequentially scanned), are scanned with a time lag of a half-frame period in the case of FIG. 14.

In order to solve the problem, it is conceivable to drive the scanning signal line of the display section as shown in FIG. 15, i.e., so that the scanning of G541 (scanning signal line at the head the second area) to be carried out for displaying a frame (N+1) may be started immediately after the scanning of G540 (scanning signal line at the tail of the first area) to be carried out for displaying the frame (N+1).

### Citation List

Patent Literature 1

Japanese Patent Application Publication, Tokukaihei, No. 11-102172 A (Publication Date: Apr. 13, 1999)

### SUMMARY OF THE INVENTION

However, the inventors of the present invention found that driving scanning signal lines as shown in FIG. 15 led to the following problem. Specifically, only scanning signal lines (G541, G542, . . . ) in the second area are scanned in a period between a scanning of the scanning signal line G540 at the tail of the first area and a scanning of the scanning signal line G1 at the head of the first area (i.e., scanned in a blanking period of the first area). On the other hand, both scanning signal lines (G1, G2, . . . ) in the first area and scanning signal lines (G545, G546, . . . ) in the second area are scanned after the scanning of G1 is started. This results in (i) those scanning signal lines in either one of the two areas which are scanned while scanning signal lines in the other area are also scanned (i.e., G1 through G536 and G545 through G1080) and (ii) those scanning signal lines in either one of the two areas which are scanned while no scanning signal line in the other area is scanned (i.e., G537 through G544). Accordingly, while such scanning signal lines G537 through G544 are scanned, each of the gate drivers 103 and 103′ has a lower load than while the scanning signal lines G1 through G536 and G545 through G1080 are scanned. As a result, that part of a display screen which corresponds to the scanning signal lines G537 through G544 can be visually recognized as belt-like display unevenness.

The present invention was made in view of the problem. An object of the present invention is to propose, for a display apparatus which has a display section divided into a first area and a second area and which drives the first area and the second area separately, an arrangement in which belt-like display unevenness caused at the center of a display screen is visually less recognizable.

A display apparatus of the present invention is a display apparatus having a display section provided with a first area and a second area each having formed therein data signal lines, scanning signal lines, and pixels, the scanning of the scanning signal lines in the first area and the scanning of the scanning signal lines in the second area being carried out separately so that a part of a frame is displayed in the first area and a remaining part of the frame is displayed in the second area, wherein in a case where (i) respective scanning directions in the first area and the second area are identical and (ii) a scanning signal line to be scanned first in the first area, a scanning signal line to be scanned last in the first area, a scanning signal line to be scanned first in the second area, and a scanning signal line to be scanned last in the second area are referred to as a first starting scanning signal line, a first ending scanning signal line, a second starting scanning signal line, and a second ending scanning signal line, respectively, in display processing of one frame, the second starting scanning signal line is scanned at a predetermined timing after the first starting scanning signal line is scanned, and at least one scanning signal line in the second area is scanned in a period which follows a scanning of the first ending scanning signal line and in which period no scanning is carried out in the first area; and in display processing of another frame, the second starting scanning signal line is scanned at a timing different from the predetermined timing. The timings above are determined relative to, e.g., a timing of the scanning of the first starting scanning signal line or the scanning of the first ending scanning signal line.

The arrangement makes it possible to shift, frame by frame, the belt-like display unevenness caused at the center of the display screen by those scanning signal lines in either one of the two areas which are scanned while no scanning signal line in the other area is scanned. This makes it possible to make the belt-like display unevenness visually less recognizable as compared with a conventional arrangement in which such belt-like display unevenness is always caused in a same position.

The display apparatus of the present invention can be arranged such that the predetermined timing comes after the first ending scanning signal line is scanned. Further, the display apparatus of the present invention can be arranged such that, in display processing of each of frames, the second starting scanning signal line is scanned after the first ending scanning signal line is scanned. The arrangement makes it possible to eliminate an out-of-sync display at a boundary between the first area and the second area.

The display apparatus of the present invention can be arranged such that the second starting scanning signal line is scanned at a same timing in display processing of any frames that show up at predetermined cycles. This makes it possible to shift the belt-like display unevenness caused at the center of the display screen in cycles.

The display apparatus of the present invention can be arranged such that a timing when to scan the second starting scanning signal line is shifted, by one horizontal scanning period, between two consecutive frames. Further, the display apparatus of the present invention can be arranged such that the predetermined timing comes one horizontal scanning period after the first ending scanning signal line is scanned. Further, the display apparatus of the present invention can be arranged such that a scanning signal line to be scanned in the second area in a period except the period which follows the scanning of the first ending scanning signal line and in which period no scanning is carried out in the first area is scanned at a same timing as a scanning of any scanning signal line in the first area. The arrangement simplifies an arrangement for controlling a scanning timing (e.g., the arrangement simplifies a setting of a timing controller).

A display apparatus of the present invention is a display apparatus having a display section provided with a first area and a second area each having formed therein data signal lines, scanning signal lines, and pixels, the scanning of the scanning signal lines in the first area and the scanning of the scanning signal lines in the second area being carried out separately so that a part of a frame is displayed in the first area and a remaining part of the frame is displayed in the second area, wherein in a case where (i) respective scanning directions in the first area and the second area are identical and (ii) a scanning signal line to be scanned first in the first area, a scanning signal line to be scanned last in the first area, a scanning signal line to be scanned first in the second area, and a scanning signal line to be scanned last in the second area are referred to as a first starting scanning signal line, a first ending scanning signal line, a second starting scanning signal line, and a second ending scanning signal line, respectively, in display processing of one frame, the second starting scanning signal line is scanned after the first ending scanning signal line is scanned; and a scanning of the second starting scanning signal line for displaying one frame is carried out at a same timing as a scanning of the first starting scanning signal line to be carried out for displaying a next frame.

The arrangement makes it possible to eliminate that scanning signal line in either one of the two areas which is scanned while no scanning signal line in the other area is scanned. This makes it possible to eliminate the belt-like display unevenness which has been conventionally caused at the center of the display screen by those scanning signal lines in either one of the two areas which are scanned while no scanning signal line in the other area is scanned.

A display apparatus of the present invention is a display apparatus having a display section provided with a first area and a second area each having formed therein data signal lines, scanning signal lines, and pixels, the display apparatus having a dummy scanning signal line outside the display section, the scanning of the scanning signal lines in the first area and the scanning of the scanning signal lines in the second area being carried out separately so that a part of a frame is displayed in the first area and a remaining part of the frame is displayed in the second area, wherein in a case where (i) respective scanning directions in the first area and the second area are identical and (ii) a scanning signal line to be scanned first in the first area, a scanning signal line to be scanned last in the first area, a scanning signal line to be scanned first in the second area, and a scanning signal line to be scanned last in the second area are referred to as a first starting scanning signal line, a first ending scanning signal line, a second starting scanning signal line, and a second ending scanning signal line, respectively, in display processing of one frame, the second starting scanning signal line is scanned after the first ending scanning signal line is scanned; in a first period which follows a scanning period of the first ending scanning signal line and in which first period no scanning is carried out in the first area, at least one scanning signal line in the second area is scanned; and, in a second period which follows a scanning period of the second ending scanning signal line and in which second period no scanning is carried out in the second area, at least one scanning signal line in the first area is scanned, and the dummy scanning signal lines is scanned so as to temporally overlap (i) a scanning of the second area in the first period and (ii) a scanning of the first area in the second period.

The arrangement makes it possible to eliminate that scanning signal line in either one of the two areas which is scanned while no scanning signal line or no dummy scanning signal line in the other area is scanned. This makes it possible to eliminate the belt-like display unevenness which has been conventionally caused at the center of the display screen by those scanning signal lines in either one of the two areas which are scanned while no scanning signal line in the other area is scanned.

A display apparatus of the present invention is a display apparatus having a display section provided with a first area and a second area each having formed therein data signal lines, scanning signal lines, and pixels, the scanning of the scanning signal lines in the first area and the scanning of the scanning signal lines in the second area being carried out separately so that a part of a frame is displayed in the first area and a remaining part of the frame is displayed in the second area, and the scanning signal lines, of the first area and the second area, receiving respective scanning voltages from a scanning voltage output circuit, wherein in a case where (i) respective scanning directions in the first area and the second area are identical and (ii) a scanning signal line to be scanned first in the first area, a scanning signal line to be scanned last in the first area, a scanning signal line to be scanned first in the second area, and a scanning signal line to be scanned last in the second area are referred to as a first starting scanning signal line, a first ending scanning signal line, a second starting scanning signal line, and a second ending scanning signal line, respectively, in display processing of one frame, the second starting scanning signal line is scanned after the first ending scanning signal line is scanned; at least one scanning signal line in the second area is scanned in a first period which follows a scanning period of the first ending scanning signal line and in which first period no scanning is carried out in the first area; and at least one scanning signal line in the first area is scanned in a second period which follows a scanning period of the second ending scanning signal line and in which second period no scanning is carried out in the second area, and a predetermined load is applied to the scanning voltage output circuit so as to temporally overlap (I) a scanning of the second area in the first period and (II) a scanning of the first area in the second period.

The arrangement makes it possible to apply a load (e.g., a load corresponding to one scanning signal line) to the scanning voltage output circuit in a case where a scanning signal line in either one of the two areas is scanned while no scanning signal line is scanned in the other area. This makes it possible to eliminate the belt-like display unevenness which has been conventionally caused at the center of the display screen by those scanning signal lines in either one of the two areas which are scanned while no scanning signal line in the other area is scanned.

A liquid crystal display apparatus of the present invention includes any one of the display apparatuses. A television receiver of the present invention includes the liquid crystal display apparatus and a tuner section for receiving a television broadcast.

A method of the present invention for driving a display apparatus is a method for driving a display apparatus having a display section provided with a first area and a second area each having formed therein data signal lines, scanning signal lines, and pixels, the scanning of the scanning signal lines in the first area and the scanning of the scanning signal lines in the second area being carried out separately so that a part of a frame is displayed in the first area and a remaining part of the frame is displayed in the second area, wherein in a case where (i) respective scanning directions in the first area and the second area are identical and (ii) a scanning signal line to be scanned first in the first area, a scanning signal line to be scanned last in the first area, a scanning signal line to be scanned first in the second area, and a scanning signal line to be scanned last in the second area are referred to as a first starting scanning signal line, a first ending scanning signal line, a second starting scanning signal line, and a second ending scanning signal line, respectively, in display processing of one frame, the second starting scanning signal line is scanned at a predetermined timing after the first starting scanning signal line is scanned, and at least one scanning signal line in the second area is scanned in a period which follows a scanning of the first ending scanning signal line and in which period no scanning is carried out in the first area; and in display processing of another frame, the second starting scanning signal line is scanned at a timing different from the predetermined timing.

A control apparatus, of the present invention, of a display apparatus is a control apparatus for driving a display apparatus having a display section provided with a first area and a second area each having formed therein data signal lines, scanning signal lines, and pixels, the scanning of the scanning signal lines in the first area and the scanning of the scanning signal lines in the second area being carried out separately so that a part of a frame is displayed in the first area and a remaining part of the frame is displayed in the second area, wherein in a case where (i) respective scanning directions in the first area and the second area are identical and (ii) a scanning signal line to be scanned first in the first area, a scanning signal line to be scanned last in the first area, a scanning signal line to be scanned first in the second area, and a scanning signal line to be scanned last in the second area are referred to as a first starting scanning signal line, a first ending scanning signal line, a second starting scanning signal line, and a second ending scanning signal line, respectively, in display processing of one frame, the second starting scanning signal line is scanned at a predetermined timing after the first starting scanning signal line is scanned, and at least one scanning signal line in the second area is scanned in a period which follows a scanning of the first ending scanning signal line and in which period no scanning is carried out in the first area; and in display processing of another frame, the second starting scanning signal line is scanned at a timing different from the predetermined timing.

A method of the present invention for driving a display apparatus having a display section provided with a first area and a second area each having formed therein data signal lines, scanning signal lines, and pixels, the scanning of the scanning signal lines in the first area and the scanning of the scanning signal lines in the second area being carried out separately so that a part of a frame is displayed in the first area and a remaining part of the frame is displayed in the second area, wherein in a case where (i) respective scanning directions in the first area and the second area are identical and (ii) a scanning signal line to be scanned first in the first area, a scanning signal line to be scanned last in the first area, a scanning signal line to be scanned first in the second area, and a scanning signal line to be scanned last in the second area are referred to as a first starting scanning signal line, a first ending scanning signal line, a second starting scanning signal line, and a second ending scanning signal line, respectively, in display processing of one frame, the second starting scanning signal line is scanned after the first ending scanning signal line is scanned; and a scanning of the second starting scanning signal line for displaying one frame is carried out at a same timing as a scanning of the first starting scanning signal line to be carried out for displaying a next frame.

A control apparatus, of the present invention, of a display apparatus is a control apparatus for driving a display apparatus having a display section provided with a first area and a second area each having formed therein data signal lines, scanning signal lines, and pixels, the scanning of the scanning signal lines in the first area and the scanning of the scanning signal lines in the second area being carried out separately so that a part of a frame is displayed in the first area and a remaining part of the frame is displayed in the second area, wherein in a case where (i) respective scanning directions in the first area and the second area are identical and (ii) a scanning signal line to be scanned first in the first area, a scanning signal line to be scanned last in the first area, a scanning signal line to be scanned first in the second area, and a scanning signal line to be scanned last in the second area are referred to as a first starting scanning signal line, a first ending scanning signal line, a second starting scanning signal line, and a second ending scanning signal line, respectively, in display processing of one frame, the second starting scanning signal line is scanned after the first ending scanning signal line is scanned; and a scanning of the second starting scanning signal line for displaying one frame is carried out at a same timing as a scanning of the first starting scanning signal line to be carried out for displaying a next frame.

A method of the present invention for driving a display apparatus is a method for driving a display apparatus having a display section provided with a first area and a second area each having formed therein data signal lines, scanning signal lines, and pixels, the display apparatus having a dummy scanning signal line outside the display section, the scanning of the scanning signal lines in the first area and the scanning of the scanning signal lines in the second area being carried out separately so that a part of a frame is displayed in the first area and a remaining part of the frame is displayed in the second area, wherein in a case where (i) respective scanning directions in the first area and the second area are identical and (ii) a scanning signal line to be scanned first in the first area, a scanning signal line to be scanned last in the first area, a scanning signal line to be scanned first in the second area, and a scanning signal line to be scanned last in the second area are referred to as a first starting scanning signal line, a first ending scanning signal line, a second starting scanning signal line, and a second ending scanning signal line, respectively, in display processing of one frame, the second starting scanning signal line is scanned after the first ending scanning signal line is scanned; in a first period which follows a scanning period of the first ending scanning signal line and in which first period no scanning is carried out in the first area, at least one scanning signal line in the second area is scanned; and, in a second period which follows a scanning period of the second ending scanning signal line and in which second period no scanning is carried out in the second area, at least one scanning signal line in the first area is scanned, and the dummy scanning signal lines is scanned so as to temporally overlap (i) a scanning of the second area in the first period and (ii) a scanning of the first area in the second period.

A control apparatus, of the present invention, of a display apparatus is a control apparatus for driving a display apparatus having a display section provided with a first area and a second area each having formed therein data signal lines, scanning signal lines, and pixels, the display apparatus having a dummy scanning signal line outside the display section, the scanning of the scanning signal lines in the first area and the scanning of the scanning signal lines in the second area being carried out separately so that a part of a frame is displayed in the first area and a remaining part of the frame is displayed in the second area, wherein in a case where (i) respective scanning directions in the first area and the second area are identical and (ii) a scanning signal line to be scanned first in the first area, a scanning signal line to be scanned last in the first area, a scanning signal line to be scanned first in the second area, and a scanning signal line to be scanned last in the second area are referred to as a first starting scanning signal line, a first ending scanning signal line, a second starting scanning signal line, and a second ending scanning signal line, respectively, in display processing of one frame, the second starting scanning signal line is scanned after the first ending scanning signal line is scanned; in a first period which follows a scanning period of the first ending scanning signal line and in which first period no scanning is carried out in the first area, at least one scanning signal line in the second area is scanned; and, in a second period which follows a scanning period of the second ending scanning signal line and in which second period no scanning is carried out in the second area, at least one scanning signal line in the first area is scanned, and the dummy scanning signal lines is scanned so as to temporally overlap (i) a scanning of the second area in the first period and (ii) a scanning of the first area in the second period.

A method of the present invention for driving a display apparatus is a method for driving a display apparatus having a display section provided with a first area and a second area each having formed therein data signal lines, scanning signal lines, and pixels, the display apparatus having a dummy scanning signal line outside the display section, the scanning of the scanning signal lines in the first area and the scanning of the scanning signal lines in the second area being carried out separately so that a part of a frame is displayed in the first area and a remaining part of the frame is displayed in the second area, wherein in a case where (i) respective scanning directions in the first area and the second area are identical and (ii) a scanning signal line to be scanned first in the first area, a scanning signal line to be scanned last in the first area, a scanning signal line to be scanned first in the second area, and a scanning signal line to be scanned last in the second area are referred to as a first starting scanning signal line, a first ending scanning signal line, a second starting scanning signal line, and a second ending scanning signal line, respectively, in display processing of one frame, the second starting scanning signal line is scanned after the first ending scanning signal line is scanned; at least one scanning signal line in the second area is scanned in a first period which follows a scanning period of the first ending scanning signal line and in which first period no scanning is carried out in the first area; and at least one scanning signal line in the first area is scanned in a second period which follows a scanning period of the second ending scanning signal line and in which second period no scanning is carried out in the second area, and a predetermined load is applied to the scanning voltage output circuit so as to temporally overlap (I) a scanning of the second area in the first period and (II) a scanning of the first area in the second period.

A control apparatus, of the present invention, of a display apparatus is a control apparatus for driving a display apparatus having a display section provided with a first area and a second area each having formed therein data signal lines, scanning signal lines, and pixels, the display apparatus having a dummy scanning signal line outside the display section, the scanning of the scanning signal lines in the first area and the scanning of the scanning signal lines in the second area being carried out separately so that a part of a frame is displayed in the first area and a remaining part of the frame is displayed in the second area, and the scanning signal lines, of the first area and the second area, receiving respective scanning voltages from a scanning voltage output circuit, wherein in a case where (i) respective scanning directions in the first area and the second area are identical and (ii) a scanning signal line to be scanned first in the first area, a scanning signal line to be scanned last in the first area, a scanning signal line to be scanned first in the second area, and a scanning signal line to be scanned last in the second area are referred to as a first starting scanning signal line, a first ending scanning signal line, a second starting scanning signal line, and a second ending scanning signal line, respectively, in display processing of one frame, the second starting scanning signal line is scanned after the first ending scanning signal line is scanned; at least one scanning signal line in the second area is scanned in a first period which follows a scanning period of the first ending scanning signal line and in which first period no scanning is carried out in the first area; and at least one scanning signal line in the first area is scanned in a second period which follows a scanning period of the second ending scanning signal line and in which second period no scanning is carried out in the second area, and a predetermined load is applied to the scanning voltage output circuit so as to temporally overlap (I) a scanning of the second area in the first period and (II) a scanning of the first area in the second period.

As described above, the present invention allows the display apparatus which has the display section divided into the first area and the second area and which drives the first area and the second area separately to shift, frame by frame, the belt-like display unevenness caused at the center of the display screen by those scanning signal lines in either one of the two areas which are scanned while no scanning signal line in the other area is scanned. This makes it possible to make the belt-like display unevenness visually less recognizable as compared with the conventional arrangement in which such belt-like display unevenness is always caused in a same position.

### BRIEF DESCRIPTION OF DRAWINGS

FIG. 1 is a schematic view showing how frames are displayed by a liquid crystal display apparatus.

FIG. 2 is a block diagram showing how frames are displayed according to a first embodiment.

FIG. 3 is a timing chart showing a scanning method of a liquid crystal display apparatus of the first embodiment.

FIG. 4 is a timing chart showing another scanning method of the liquid crystal display apparatus of the first embodiment.

FIG. 5 is a timing chart showing still another scanning method of the liquid crystal display apparatus of the first embodiment.

FIG. 6 is a timing chart showing a scanning method of a liquid crystal display apparatus of a second embodiment.

FIG. 7 is a timing chart showing a scanning method of a liquid crystal display apparatus of a third embodiment.

FIG. 8 is a timing chart showing a scanning method of a liquid crystal display apparatus of a fourth embodiment.

FIG. 9 is a schematic view illustrating an arrangement of the liquid crystal display apparatuses of the first, second and fourth embodiments.

FIG. 10 is a schematic view illustrating an arrangement of the liquid crystal display apparatus of the third embodiment.

FIG. 11 is a schematic view illustrating an arrangement of a driver control circuit of the fourth embodiment.

FIG. 12 is a circuit diagram illustrating one example of an arrangement using a load circuit and a switching element which are illustrated in FIG. 11.

FIG. 13 is a block diagram illustrating an arrangement of a liquid crystal television.

FIG. 14 is a timing chart showing a scanning method of a conventional liquid crystal display apparatus.

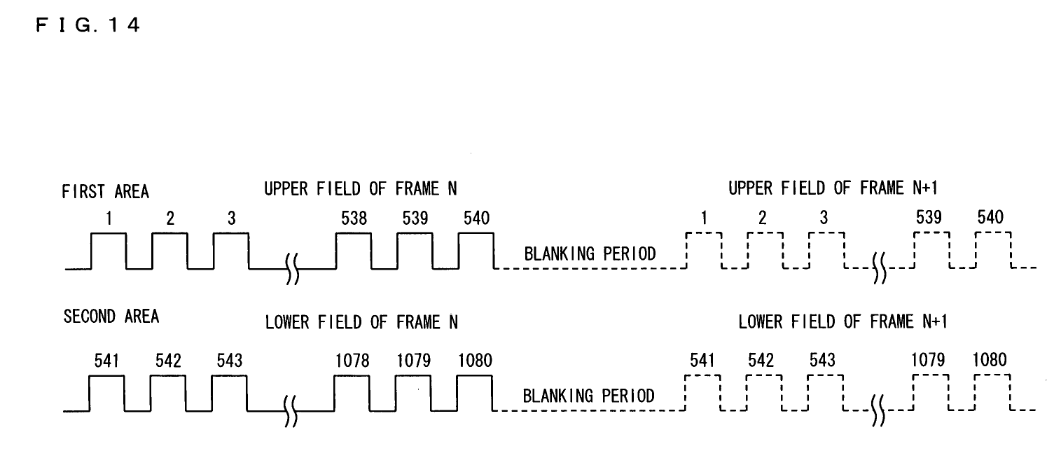

FIG. 15 is a timing chart showing a scanning method of a conventional liquid crystal display apparatus.

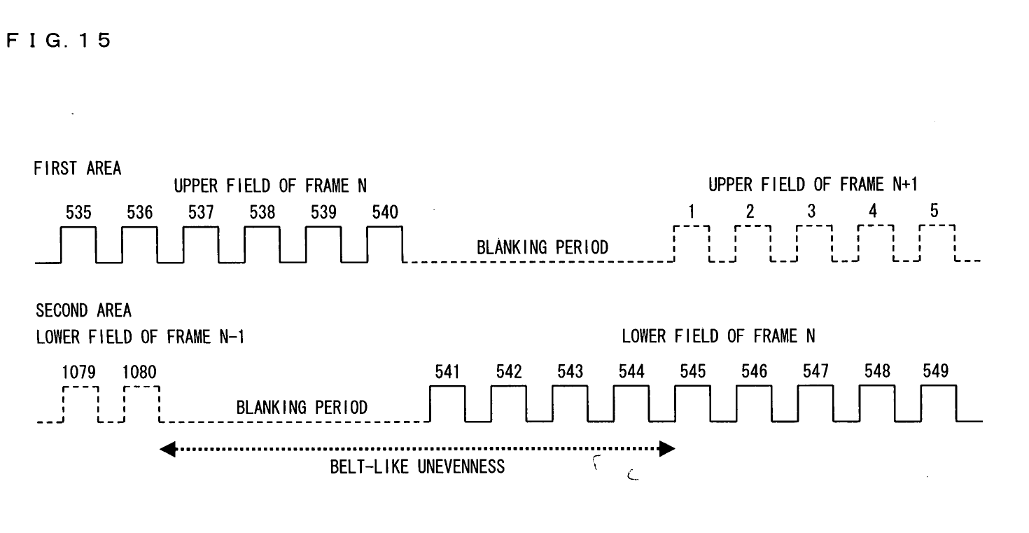

FIG. 16 is a schematic view of an arrangement of a conventional liquid crystal display apparatus.

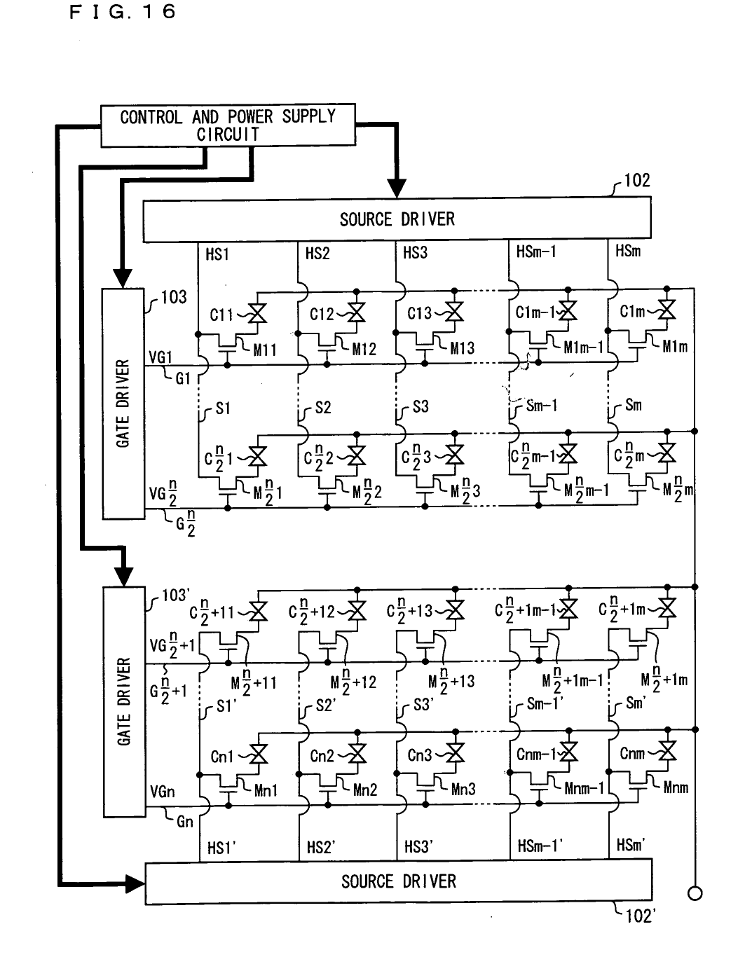

### REFERENCE SIGNS LIST

1 Liquid crystal display apparatus

2 Display section

3 Driver control circuit

7F and 7S Scanning voltage output circuit

FA First area (of the display section)

SA Second area (of the display section)

GDF First gate driver

GDS Second gate driver

UFi Upper field

DFi Lower field

G1 through Gk, and Gk+1 through Gm

Scanning signal lines

SWF Switching element

Tcon Timing controller

### DESCRIPTION OF EMBODIMENTS

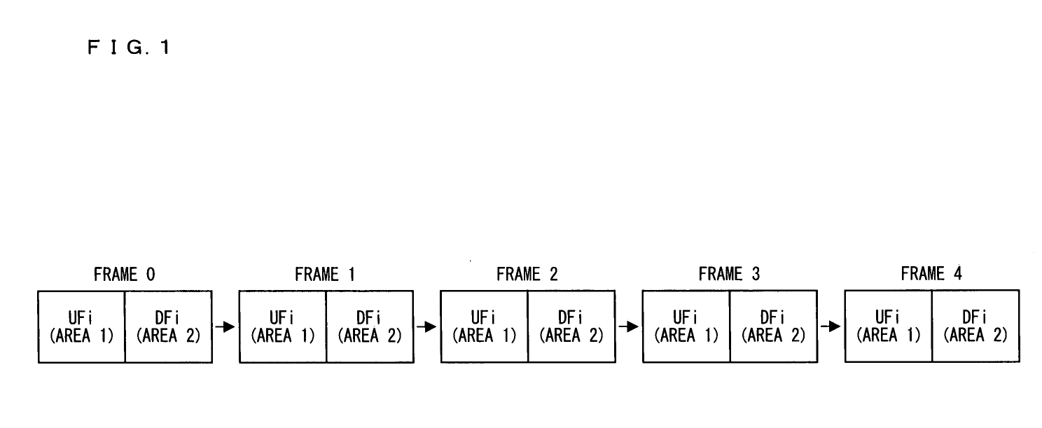

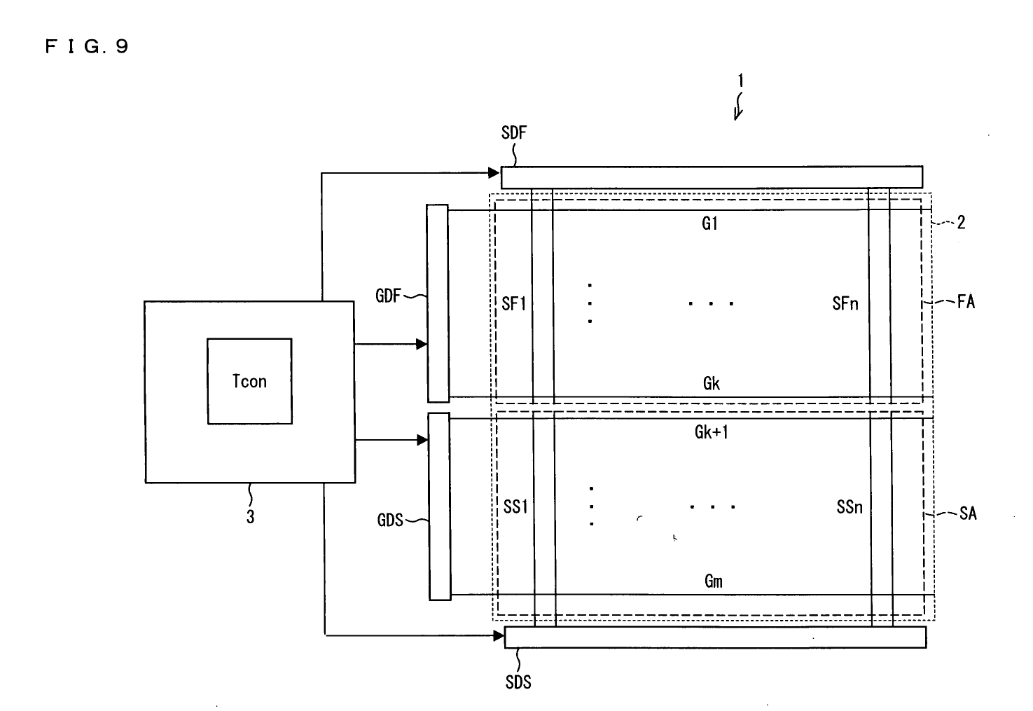

The following describes embodiments of the present invention with reference to FIGS. 1 through 13. FIG. 9 is a block diagram illustrating an arrangement of a liquid crystal display apparatus. As illustrated in FIG. 9, a liquid crystal display apparatus 1 includes: a display section 2, a first gate driver GDF (first scanning signal line drive circuit), a second gate driver GDS (second scanning signal line drive circuit), a first source driver SDF (first data signal line drive circuit), a second source driver SDS (second data signal line drive circuit), and a driver control circuit 3.

The display section 2 is divided into a first area FA and a second area SA. The first area FA includes data signal lines SF1 through SFn and scanning signal lines G1 (first scanning signal line) through Gk (“k”-th scanning signal line), and the second area SA includes data signal lines SS1 through SSn and scanning signal lines Gk+1 ((k+1)th scanning signal line) through Gm (“m”-th scanning signal line). The first area FA and the second area SA are driven separately. Specifically, in the first area FA, the data signal lines SF1 through SFn are driven by the first source driver SDF, and the scanning signal lines G1 through Gk are driven by the first gate driver GDF. In the second area SA, the data signal lines SS1 through SSn are driven by the second source driver SDS, and the scanning signal lines Gk+1 through Gm are driven by the second gate driver GDS. Hereinafter, Gk, Gk+1, and Gm are referred to as G540, G541, and G1080, respectively. The driver control circuit 3 (i.e., a control device of the liquid crystal display apparatus 1) controls the first gate driver GDF, the second gate driver GDS, the first source driver SDF, and the second source driver SDS. The driver control circuit 3 includes a timing controller Tcon, for example. The timing controller Tcon supplies both the first gate driver GDF and the second gate driver GDS with a signal for controlling a timing when to scan each of the scanning signal lines.

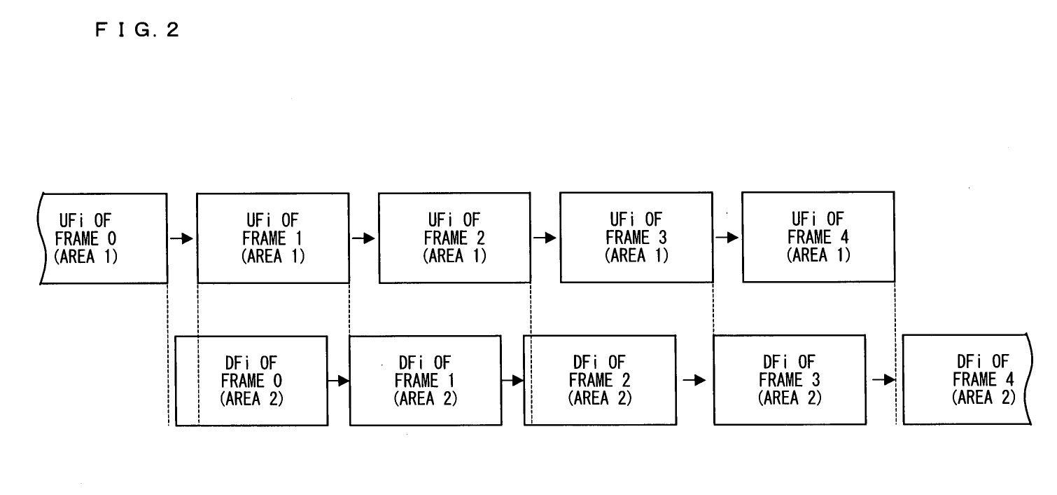

As shown in FIG. 1, the liquid crystal display apparatus 1 displays an upper half (upper field UFi) of one frame in the first area FA while displaying a lower half (lower field DFi) of the one frame in the second area SA. Accordingly, as shown in FIG. 2, respective upper fields UFi of frames are sequentially displayed in the first area SA. On the other hand, respective lower fields DFi of the frames are sequentially displayed in the second area SA. For both the first area and the second area, a blanking period is provided between one field and another. In display processing of the upper fields UFi, the scanning signal lines G1 (first starting scanning signal line) through G540 (first ending scanning signal line) in the first area are scanned in this order. On the other hand, in display processing of the lower fields DFi, the scanning signal lines G541 (second starting scanning signal line) through G1080 (second ending scanning signal line) in the second area are scanned in this order. The first area FA and the second area SA are rewritten at a time. Respective scanning directions in the first area FA and in the second area SA are identical (downward in the figures).

This allows the liquid crystal display apparatus 1 to (i) scan twice as many scanning signal lines as ordinary display processing (i.e., as display processing in which the scanning signal lines are scanned individually without a display screen being divided into areas) in a case where one horizontal scanning period is equal to that of the ordinary display processing, or to (ii) double one horizontal scanning period in a case where the number of the scanning signal lines is equal to that of the ordinary display processing. Therefore, the liquid crystal display apparatus 1 is suitable for double speed drive in which the number of frames per unit time is doubled (e.g., 120 frames/second).

### First Embodiment

In the present embodiment, a timing when to scan the scanning signal line G541 at the head of the second area is shifted frame by frame with respect to a timing when to scan the scanning signal line G540 at the tail of the first area. This shifts, frame by frame, belt-like display unevenness caused at the center of a display screen, thereby making the belt-like display unevenness visually less recognizable.

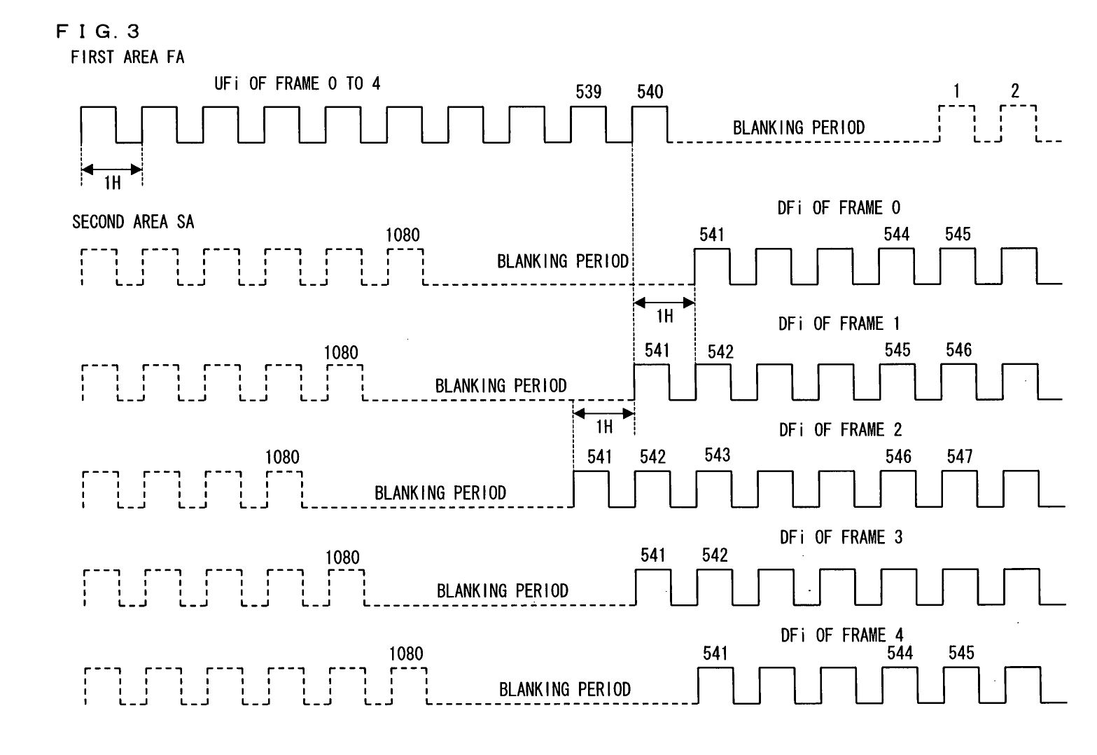

For example, frames 4j through 4j+3 (j is an integer of not less than 0 ) are displayed as shown in FIG. 2 (which shows a case where j=0). In this case, each of the scanning signal lines in the first and second areas FA and SA is scanned at a timing shown in FIG. 3. That is, in display processing of a frame 0 (4j), the scanning signal line G541 at the head of the second area SA is scanned in a blanking period (i.e., in a period in which no scanning is carried out in the first area FA) which follows a scanning of the scanning signal line G540 (i.e., scanning to be carried out for displaying an upper field of the frame 0) at the tail of the first area FA. In display processing of a frame 1 (4j+1), the scanning signal line G541 at the head of the second area SA is scanned at a same timing as a scanning of the scanning signal line G540 (scanning to be carried out for displaying an upper field of the frame 1) at the tail of the first area FA. In display processing of a frame 2 (4j+2), the scanning signal line G541 at the head of the second area SA is scanned at a same timing as a scanning of a scanning signal line G539 (scanning to be carried out for displaying an upper field of the frame 2) in the first area FA. In display processing of a frame 3 (4j+3), the scanning signal line G541 at the head of the second area SA is scanned at a same timing as a scanning of the scanning signal line G540 (scanning to be carried out for displaying an upper field of the frame 3) in the first area FA. In display processing of a frame 4 (4j), the scanning signal line G541 at the head of the second area SA is scanned in a blanking period (i.e., in a period in which no scanning is carried out in the first area FA) which follows a scanning of the scanning signal line G540 (i.e., scanning to be carried out for displaying an upper field of the frame 4) at the tail of the first area FA.

According to the present embodiment, as described above, a timing when to scan the scanning signal line G541 at the head of the second area SA is shifted frame by frame by one horizontal scanning period (1H) so that the scanning signal line G541 may be always scanned at a same timing in display processing of any frames that show up at predetermined cycles. For example, in display processing of the frame 0 and frames (frames 4, 8, . . . ) which are subsequently displayed one by one every four frames, the scanning signal line G541 is always scanned at a same timing. In display processing of the frame 1 and frames (frames 3, 5, . . . ) which are subsequently displayed one by one every two frames, the scanning signal line G541 is always scanned at a same timing. In display processing of the frame 2 and frames (frames 6, 10, . . . ) which are subsequently displayed one by one every four frames, the scanning signal line G541 is always scanned at a same timing.

In display processing of a frame 4j (frame 0, 4, . . . ), a timing when to scan the scanning signal line G541 comes one horizontal scanning period after a scanning of the scanning signal line G540.

As for that one scanning signal line in either one of the two areas which is scanned while another scanning signal line in the other area is also scanned, the one scanning line is scanned at a same timing as a scanning of the another scanning signal line. For example, a scanning of the scanning signal line G1 in the first area FA to be carried out for displaying the upper field of the frame 1 is carried out at a same timing as a scanning of the scanning signal line G545 in the first area FA to be carried out for displaying a lower field of the frame 0.

According to the present embodiment, in the case of the frame 0, those scanning signal lines in either one of the two areas which are scanned while no signal scanning line is scanned in the other area are G537 through G544. On the other hand, those scanning signal lines in either one of the two areas which are scanned while scanning signal lines in the other area are also scanned are G1 through G536 and G545 through G1080. In the case of the frame 1, those scanning signal lines in either one of the two areas which are scanned while no signal scanning line in the other area is scanned are G536 through G539 and G542 through G545. On the other hand, those scanning signal lines in either one of the two areas which are scanned while scanning signal lines in the other area are also scanned are G1 through G535, G540, G541, and G546 through G1080. In the case of the frame 2, those scanning signal lines in either one of the two areas which are scanned while no signal scanning line in the other area is scanned are G535 through G538 and G543 through G546. On the other hand, those scanning signal lines in either one of the two areas which are scanned while scanning signal lines in the other area are also scanned are G1 through G534, G539 through G542, and G547 through G1080. In the case of the frame 3, those scanning signal lines in either one of the two areas which are scanned while no signal scanning line in the other area is scanned are G536 through G539 and G542 through G545. On the other hand, those scanning signal lines in either one of the two areas which are scanned while scanning signal lines in the other area are also scanned are G1 through G535, G540, G541, and G546 through G1080.

Accordingly, the belt-like display unevenness caused at the center of the display screen by those scanning signal lines in either one of the two areas which are scanned while no scanning signal line in the other area is scanned moves along frame progression in the following manner: G537 through G544→G536 through G539 and G542 through G545→G535 through G538 and G543 through G546→G536 through G539 and G542 through G545→G537 through G544 . . . This makes it possible to make the belt-like display unevenness visually less recognizable as compared with a conventional arrangement in which such belt-like display unevenness is always caused in a same position.

This method for driving the scanning signal lines G1 through G1080 can be realized, for example, by arranging such that a timing when the timing controller Tcon supplies a gate start pulse GSP to the gate driver GDS is shifted frame by frame.

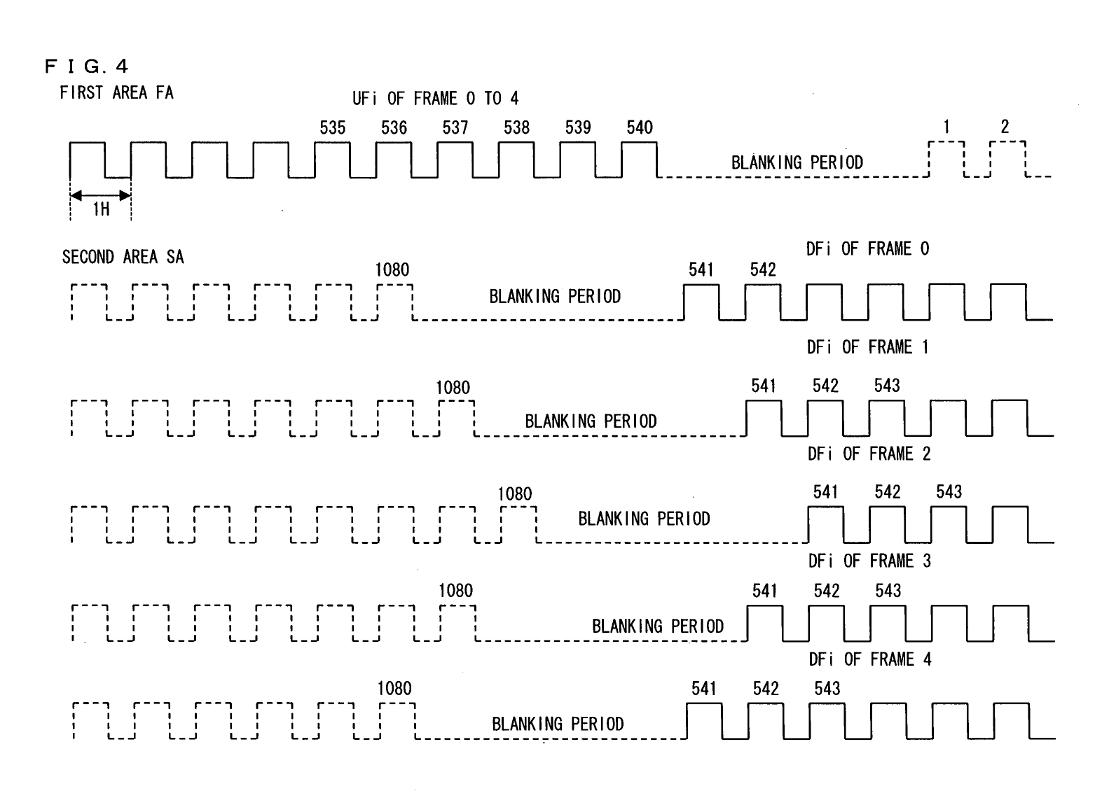

In the present embodiment, the scanning signal lines can be driven as shown in FIG. 4. Specifically, in display processing of the frame 0 (4j), the scanning signal line G541 at the head of the second area SA is scanned one horizontal scanning period (one blanking period) after the scanning signal line G540 at the tail of the first area FA is scanned (scanning for displaying the upper field of the frame 0). In display processing of the frame 1 (4j+1), the scanning signal line G541 at the head of the second area SA is scanned two horizontal scanning periods (two blanking periods) after the scanning signal line G540 is scanned (scanning for displaying the upper field of the frame 1). In display processing of the frame 2 (4j+2 ), the scanning signal line G541 at the head of the second area SA is scanned three horizontal scanning periods (three blanking periods) after the scanning signal line G540 is scanned (scanning for displaying the upper field of the frame 2). In display processing of the frame 3 (4j+3), the scanning signal line G541 at the head of the second area SA is scanned two horizontal scanning periods (two blanking periods) after the scanning signal line G540 is scanned (scanning for displaying the upper field of the frame 3). In display processing of the frame 4, the scanning signal line G541 at the head of the second area SA is scanned one horizontal scanning period (one blanking period) after the scanning signal line G540 is scanned (scanning for displaying the upper field of the frame 4).

According to a method of FIG. 4 for driving the scanning signal lines, a scanning timing of the scanning signal line G541 at the head of the second area SA is shifted frame by frame by one horizontal scanning period so that the scanning signal line G541 may be always scanned at a same timing in display processing of any frames that show up at predetermined cycles. In addition, in display processing of each of the frames, the scanning signal line G541 at the head of the second area SA is scanned after the scanning signal line G540 at the tail of the first area FA is scanned. In display processing of the frame 4j (frame 0, 4, . . . ), a timing when to scan the scanning signal line G541 comes one horizontal scanning period after a scanning of the scanning signal line G540. As for that one scanning signal line in either one of the two areas which is scanned while another scanning signal line in the other area is also scanned, the one scanning line is scanned at a same timing as a scanning of the another scanning signal line.

Accordingly, in the case of the frame 0, those scanning signal lines in either one of the two areas which are scanned while no signal scanning line in the other area is scanned are G537 through G544. On the other hand, those scanning signal lines in either one of the two areas which are scanned while scanning signal lines in the other area are also scanned are G1 through G536 and G545 through G1080. In the case of the frame 1, those scanning signal lines in either one of the two areas which are scanned while no signal scanning line in the other area is scanned are G538 through G543. On the other hand, those scanning signal lines in either one of the two areas which are scanned while scanning signal lines in the other area are also scanned are G1 through G537 and G544 through G1080. In the case of the frame 2, those scanning signal lines in either one of the two areas which are scanned while no signal scanning line in the other area is scanned are G539 through G542. On the other hand, those scanning signal lines in either one of the two areas which are scanned while scanning signal lines in the other area are also scanned are G1 through G538 and G543 through G1080. In the case of the frame 3, those scanning signal lines in either one of the two areas which are scanned while no signal scanning line in the other area is scanned are G538 through G543. On the other hand, those scanning signal lines in either one of the two areas which are scanned while scanning signal lines in the other area are also scanned are G1 through G537 and G544 through G1080. In the case of the frame 4, those scanning signal lines in either one of the two areas which are scanned while no signal scanning line in the other area is scanned are G537 through G544. On the other hand, those scanning signal lines in either one of the two areas which are scanned while scanning signal lines in the other area are also scanned are G1 through G536 and G545 through G1080.

Accordingly, the belt-like display unevenness caused at the center of the display screen by those scanning signal lines in either one of the two areas which are scanned while no scanning signal line in the other area is scanned moves along frame progression in the following manner: G537 through G544→G538 through G543→G539 through G542→G538 through G543→G537 through G544. . . This makes it possible to make the belt-like display unevenness visually less recognizable as compared with a conventional arrangement in which such belt-like display unevenness is always caused in a same position.

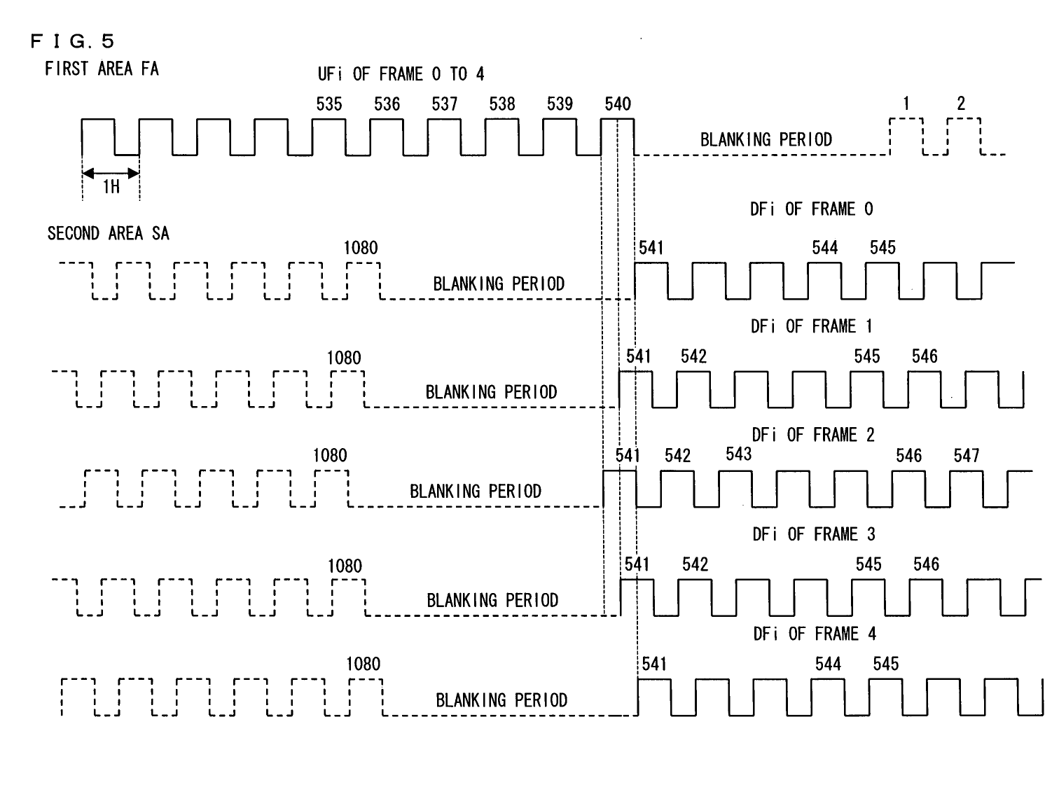

In the case of FIGS. 3 and 4, a timing when to scan the scanning signal line 541 (scanning signal line at the head of the second area SA) is shifted by one horizontal scanning period (1H) between two consecutive frames. However, the present embodiment is not limited to this. For example, as shown in FIG. 5, the timing when to scan the scanning signal line 541 (scanning signal line at the head of the second area SA) can be shifted by a period less than one horizontal scanning period (e.g., by a half of an ON period of a scanning signal line) between two consecutive frames. In addition, in display processing of a certain frame (e.g., the frame 1), a scanning of the scanning signal line 540 can be shifted from a scanning of the scanning signal line 541 by a period of a sum of (i) a period less than one horizontal scanning period or “n” (“n” is a natural number) horizontal scanning period(s) and (ii) a period less than one horizontal scanning period. As for that one scanning signal line in either one of the two areas which is scanned while the other scanning signal line in the other area is also scanned, a scanning of the one scanning signal line can be shifted from a scanning of the other scanning signal line by a period less than one horizontal scanning period (e.g., a half of an ON period of a scanning signal line).

### Second Embodiment

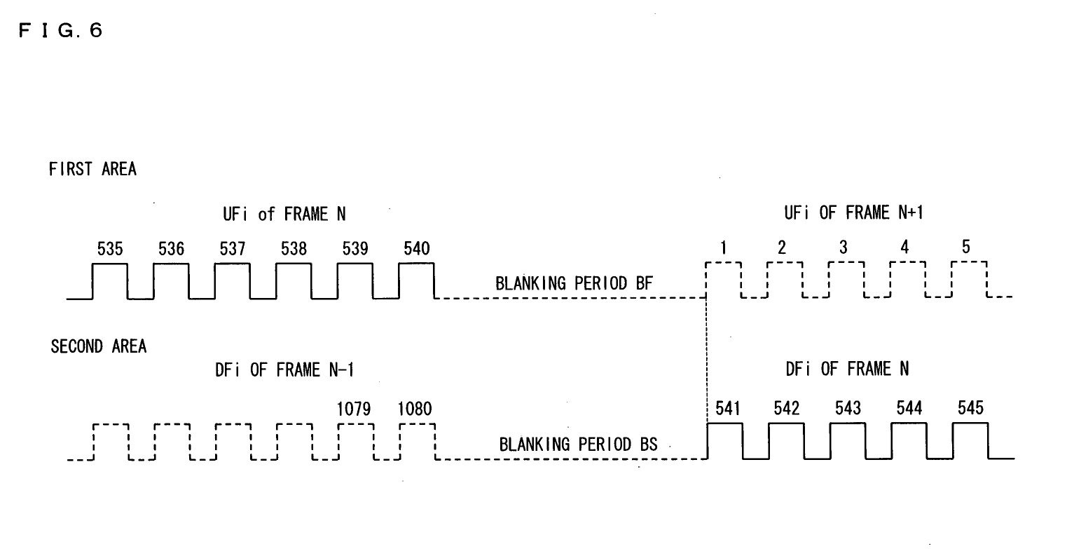

In the present embodiment, respective blanking periods of the first area FA and the second area SA are aligned with each other so that the belt-like display unevenness may not be caused at the center of the display screen. For example, as illustrated in FIG. 6, after the scanning signal line G540 (scanning signal line at the tail of the first area FA) is scanned for displaying an upper field of a frame N, a blanking period BF follows. Then, the scanning signal line G541 (scanning signal line at the head of the second area SA) is scanned for displaying a lower field of the frame N, at the same timing as a scanning of the scanning signal line G1 (scanning signal line at the head of the first area FA) for displaying an upper field of a frame (N+1). It follows that each of all the scanning signal lines (G1 through G1080) is scanned in either one of the two areas while a scanning signal line in the other area is also scanned. This makes it possible to prevent the occurrence of belt-like display unevenness which has been caused at the center of a display screen in a conventional arrangement.

### Third Embodiment

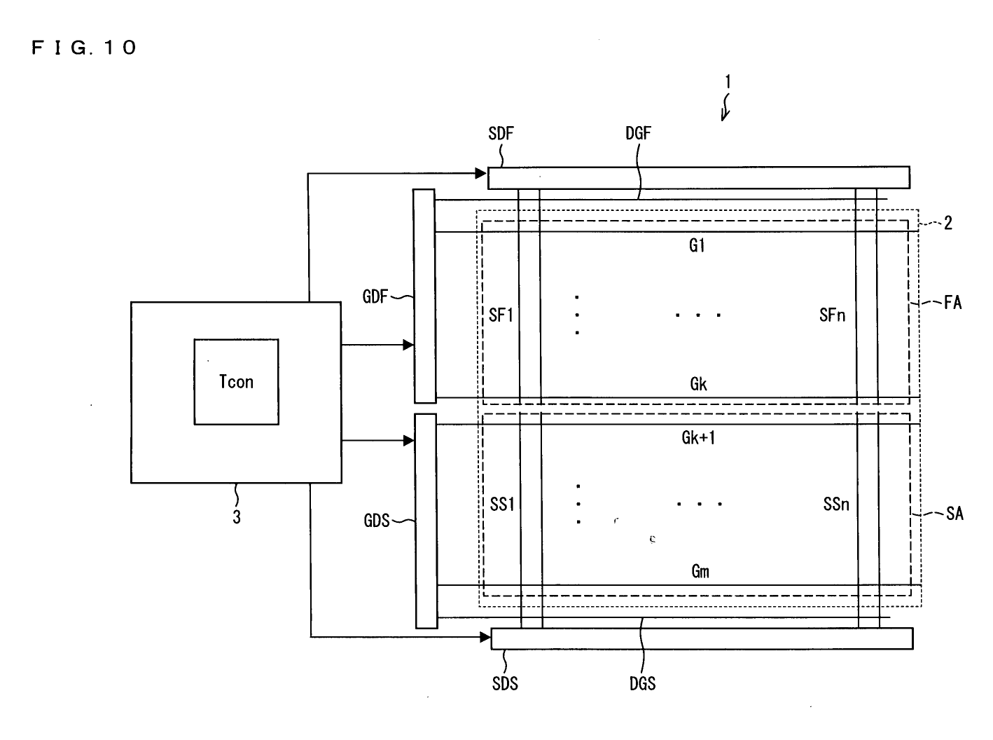

In the present embodiment, as illustrated in FIG. 10, a dummy scanning signal line DGF for the first area FA and a dummy scanning signal line DGS for the second area SA are provided outside a display section 2 so that the dummy scanning signal line DGF may be scanned in a blanking period A (a gap period between any upper field and a next upper field) of the first area FA, and the dummy scanning signal line DGS may be scanned in a blanking period B (a gap period between any lower field and a next lower field) of the second area SA, thereby preventing the occurrence of belt-like display unevenness at the center of a display screen.

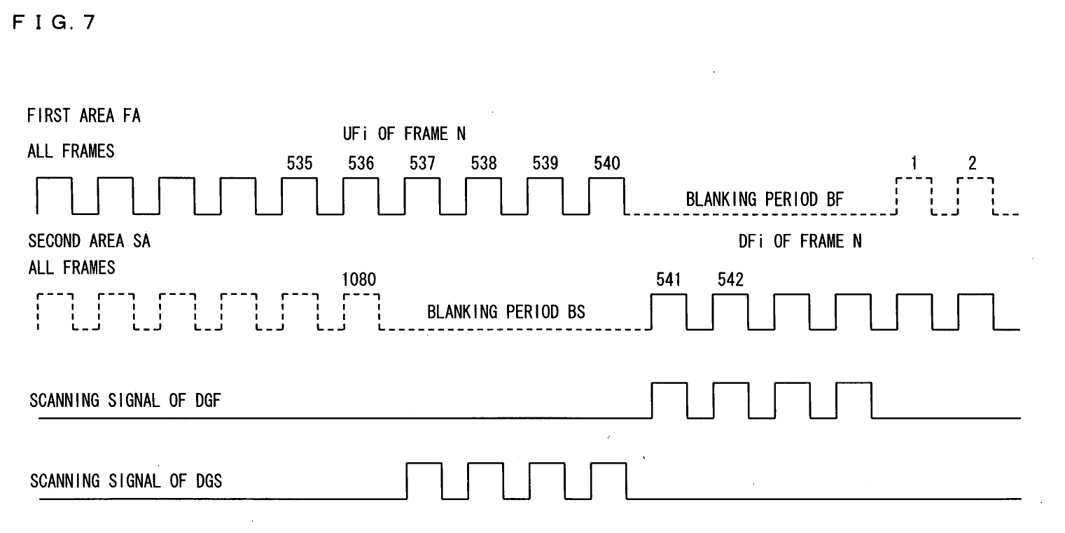

For example, as shown in FIG. 7, in a blanking period BS which comes after the scanning signal line G1080 (scanning signal line at the tail of the second area SA) is scanned for displaying a lower field of a frame (N−1), the scanning signal lines G537 through G540 (scanning signal lines in the first area FA) are scanned for displaying an upper field of a frame N. Then, in a blanking period BF which comes after the scanning signal line G540 (scanning signal line at the tail of the first area FA) is scanned for displaying the upper field of the frame N, the scanning signal lines G541 through G544 (scanning signal lines in the second area SA) are scanned for displaying a lower field of the frame N. In the blanking period BS, the dummy scanning signal line DGS is selected at the same timing as a scanning of each of the scanning signal lines G537 through G540. In the blanking period BF, the dummy scanning signal line DGF is selected at the same timing as a scanning of each of the scanning signal lines G541 through G544.

It follows that each of all the scanning signal lines (G1 through G1080) is scanned in either one of the two areas while a scanning signal line or a dummy scanning signal line in the other area is also scanned. This makes it possible to prevent the occurrence of belt-like display unevenness which has been caused at the center of a display screen in a conventional arrangement.

In the present embodiment, as illustrated in FIG. 10 for example, the dummy scanning signal line DGF provided outside the display section 2 is connected to the gate driver GDF while the dummy scanning signal line DGS provided outside the display section 2 is connected to the gate driver GDS so that the timing controller Tcon may supply the gate driver GDF with a signal for scanning (selecting) the dummy scanning signal line DGF and supply the gate driver GDS with a signal for scanning (selecting) the dummy scanning signal line DGS.

### Fourth Embodiment

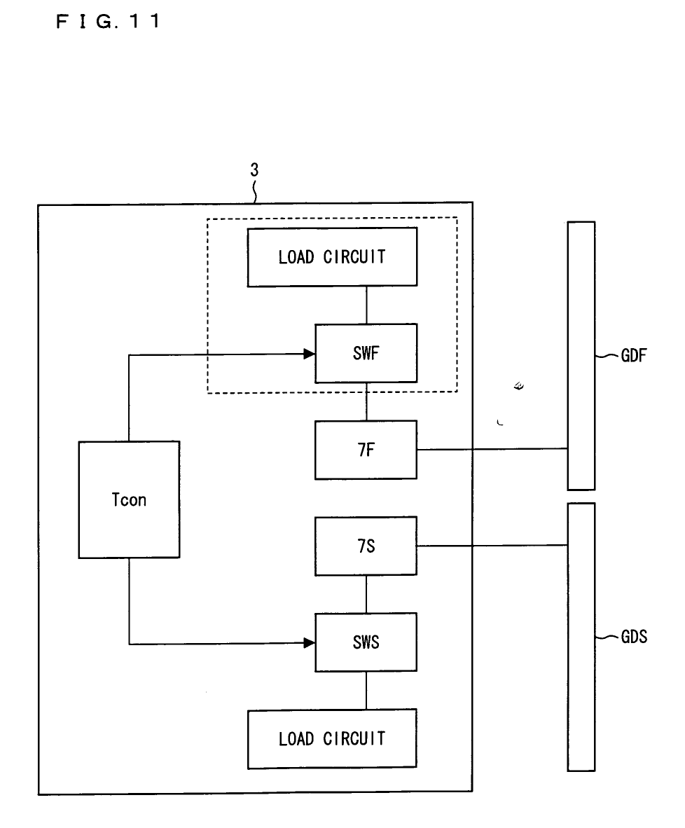

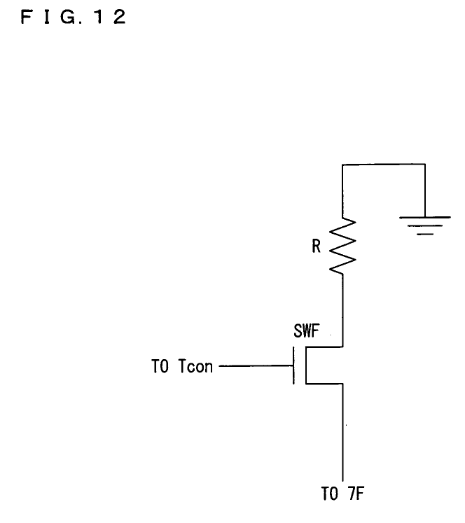

In the present embodiment, as illustrated in FIG. 11, a load circuit is connected via a switching element SWF to that scanning voltage output circuit 7F for the first gate driver GDF which is provided in a driver control circuit 3 while a load circuit is connected via a switching element SWS to that scanning voltage output circuit 7S for the second gate driver GDS which is provided in the driver control circuit 3. The switching element SWF is turned on in a blanking period A (a gap period between any upper field and a next field) of the first area SA, and the switching element SWS is turned on in a blanking period B (a gap period between any lower field and a next lower field) of the second area SA. This prevents the occurrence of belt-like display unevenness at the center of a display screen. Each of the two load circuits applies a load for one scanning signal line to a corresponding one of the scanning voltage output circuits 7F and 7S. FIG. 12 illustrates one concrete example of a part enclosed by a dashed line in FIG. 11. In the concrete example, the switching element SWF is a transistor, and the load circuit is a resistor R one terminal of which is grounded.

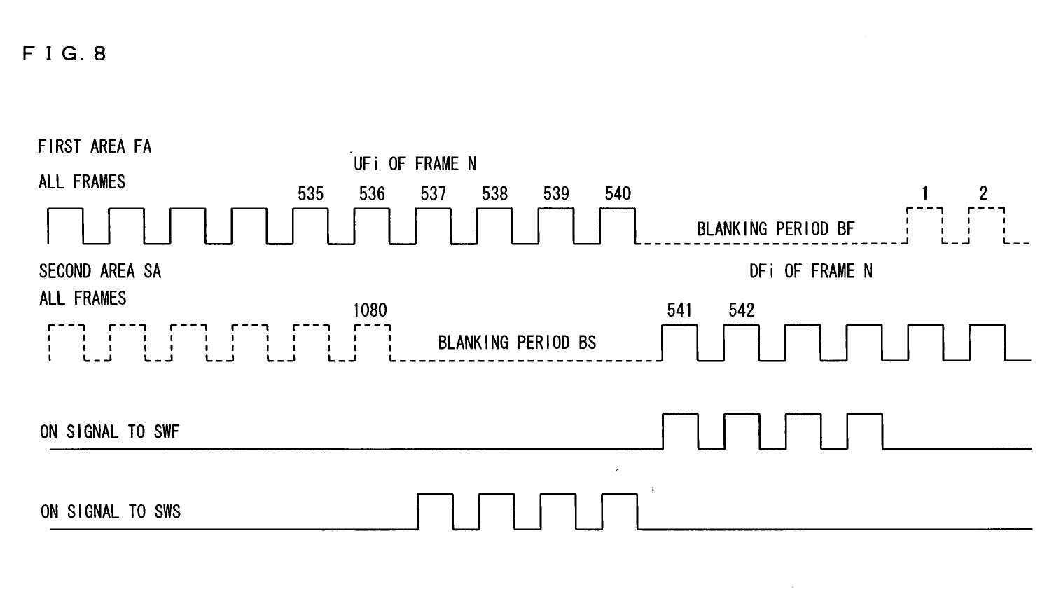

According to the present embodiment, as shown in FIG. 8 for example, in a blanking period BS which comes after the scanning signal line G1080 (scanning signal line at the tail of the second area SA) is scanned for displaying a lower field of a frame (N−1), the scanning signal lines G537 through G540 (scanning signal lines in the first area FA) are scanned for displaying an upper field of a frame N. Then, in a blanking period BF which comes after the scanning signal line G540 (scanning signal line at the tail of the first area FA) is scanned for displaying the upper field of the frame N, the scanning signal lines G541 through G544 (scanning signal lines in the second area SA) are scanned for displaying a lower field of the frame N. In the blanking period BS, the switching element SWS is turned on in sync with a scanning of each of the scanning signal lines G537 through G540, and the switching element SWS is turned on in sync with a scanning of each of the scanning signal lines G541 through G544.

This realizes a state equivalent to a state in which each of all the scanning signal lines (G1 through G1080) is scanned in either one of the two areas while a scanning signal line is scanned in the other area. As a result, this makes it possible to prevent the occurrence of belt-like display unevenness which has been caused at the center of a display screen in a conventional arrangement.

In the present embodiment, for example, the timing controller Tcon supplies an ON signal to the switching element SWF in the blanking period BF, and supplies an ON signal to the switching element SWS in the blanking period BS.

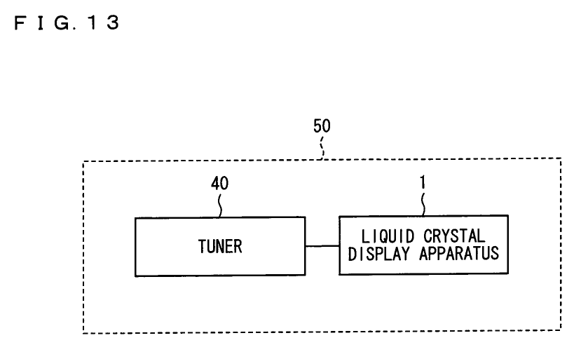

As illustrated in FIG. 13, a television receiver (liquid crystal television) of the present embodiment includes the liquid crystal display apparatus 1 and a tuner section 40 for receiving a television broadcast and outputting a video signal. That is, in a television receiver 50, the liquid crystal display apparatus 1 displays a video image (an image) in accordance with the video signal supplied from the tuner section 40.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

The display apparatus of the present invention is suitable particularly for a liquid crystal display apparatus (e.g., a liquid crystal television).

1. A display apparatus having a display section provided with a first area and a second area each having formed therein data signal lines, scanning signal lines, and pixels, the scanning of the scanning signal lines in the first area and the scanning of the scanning signal lines in the second area being carried out separately so that a part of a frame is displayed in the first area and a remaining part of the frame is displayed in the second area,
wherein
in a case where (i) respective scanning directions in the first area and the second area are identical and (ii) a scanning signal line to be scanned first in the first area, a scanning signal line to be scanned last in the first area, a scanning signal line to be scanned first in the second area, and a scanning signal line to be scanned last in the second area are referred to as a first starting scanning signal line, a first ending scanning signal line, a second starting scanning signal line, and a second ending scanning signal line, respectively,
in display processing of one frame, the second starting scanning signal line is scanned at a predetermined timing after the first starting scanning signal line is scanned, and at least one scanning signal line in the second area is scanned in a period which follows a scanning of the first ending scanning signal line and in which period no scanning is carried out in the first area; and
in display processing of another frame, the second starting scanning signal line is scanned at a timing different from the predetermined timing.

2. The display apparatus as set forth in claim 1, wherein the predetermined timing comes after the first ending scanning signal line is scanned.

3. The display apparatus as set forth in claim 1, wherein the second starting scanning signal line is scanned at a same timing in display processing of any frames that show up at predetermined cycles.

4. The display apparatus as set forth in claim 1, wherein in display processing of each of frames, the second starting scanning signal line is scanned after the first ending scanning signal line is scanned.

5. The display apparatus as set forth in claim 1, wherein a timing when to scan the second starting scanning signal line is shifted, by one horizontal scanning period, between two consecutive frames.

6. The display apparatus as set forth in claim 1, wherein the predetermined timing comes one horizontal scanning period after the first ending scanning signal line is scanned.

7. The display apparatus as set forth in claim 1, wherein a scanning signal line to be scanned in the second area in a period except the period which follows the scanning of the first ending scanning signal line and in which period no scanning is carried out in the first area is scanned at a same timing as a scanning of any scanning signal line in the first area.

8. A display apparatus having a display section provided with a first area and a second area each having formed therein data signal lines, scanning signal lines, and pixels, the scanning of the scanning signal lines in the first area and the scanning of the scanning signal lines in the second area being carried out separately so that a part of a frame is displayed in the first area and a remaining part of the frame is displayed in the second area,
wherein
in a case where (i) respective scanning directions in the first area and the second area are identical and (ii) a scanning signal line to be scanned first in the first area, a scanning signal line to be scanned last in the first area, a scanning signal line to be scanned first in the second area, and a scanning signal line to be scanned last in the second area are referred to as a first starting scanning signal line, a first ending scanning signal line, a second starting scanning signal line, and a second ending scanning signal line, respectively,
in display processing of one frame, the second starting scanning signal line is scanned after the first ending scanning signal line is scanned; and
a scanning of the second starting scanning signal line for displaying one frame is carried out at a same timing as a scanning of the first starting scanning signal line to be carried out for displaying a next frame.

9. A display apparatus having a display section provided with a first area and a second area each having formed therein data signal lines, scanning signal lines, and pixels, the display apparatus having a dummy scanning signal line outside the display section, the scanning of the scanning signal lines in the first area and the scanning of the scanning signal lines in the second area being carried out separately so that a part of a frame is displayed in the first area and a remaining part of the frame is displayed in the second area,
wherein
in a case where (i) respective scanning directions in the first area and the second area are identical and (ii) a scanning signal line to be scanned first in the first area, a scanning signal line to be scanned last in the first area, a scanning signal line to be scanned first in the second area, and a scanning signal line to be scanned last in the second area are referred to as a first starting scanning signal line, a first ending scanning signal line, a second starting scanning signal line, and a second ending scanning signal line, respectively,
in display processing of one frame, the second starting scanning signal line is scanned after the first ending scanning signal line is scanned; in a first period which follows a scanning period of the first ending scanning signal line and in which first period no scanning is carried out in the first area, at least one scanning signal line in the second area is scanned; and, in a second period which follows a scanning period of the second ending scanning signal line and in which second period no scanning is carried out in the second area, at least one scanning signal line in the first area is scanned, and
the dummy scanning signal lines is scanned so as to temporally overlap (i) a scanning of the second area in the first period and (ii) a scanning of the first area in the second period.

10. A display apparatus having a display section provided with a first area and a second area each having formed therein data signal lines, scanning signal lines, and pixels, the scanning of the scanning signal lines in the first area and the scanning of the scanning signal lines in the second area being carried out separately so that a part of a frame is displayed in the first area and a remaining part of the frame is displayed in the second area, and the scanning signal lines, of the first area and the second area, receiving respective scanning voltages from a scanning voltage output circuit,
wherein
in a case where (i) respective scanning directions in the first area and the second area are identical and (ii) a scanning signal line to be scanned first in the first area, a scanning signal line to be scanned last in the first area, a scanning signal line to be scanned first in the second area, and a scanning signal line to be scanned last in the second area are referred to as a first starting scanning signal line, a first ending scanning signal line, a second starting scanning signal line, and a second ending scanning signal line, respectively,
in display processing of one frame, the second starting scanning signal line is scanned after the first ending scanning signal line is scanned; at least one scanning signal line in the second area is scanned in a first period which follows a scanning period of the first ending scanning signal line and in which first period no scanning is carried out in the first area; and at least one scanning signal line in the first area is scanned in a second period which follows a scanning period of the second ending scanning signal line and in which second period no scanning is carried out in the second area, and
a predetermined load is applied to the scanning voltage output circuit so as to temporally overlap (I) a scanning of the second area in the first period and (II) a scanning of the first area in the second period.

11. A liquid crystal display apparatus comprising a display apparatus recited in claim 1.

12. A television receiver comprising:
a liquid crystal display apparatus recited in claim 11; and
a tuner section for receiving a television broadcast.

13. A liquid crystal display apparatus comprising a display apparatus recited in claim 8.

14. A liquid crystal display apparatus comprising a display apparatus recited in claim 9.

15. A liquid crystal display apparatus comprising a display apparatus recited in claim 10.

16. A television receiver comprising:
a liquid crystal display apparatus recited in claim 13; and
a tuner section for receiving a television broadcast.

17. A television receiver comprising:
a liquid crystal display apparatus recited in claim 14; and
a tuner section for receiving a television broadcast.

18. A television receiver comprising:
a liquid crystal display apparatus recited in claim 15; and
a tuner section for receiving a television broadcast.
